(19) United States
(12) Patent Application Publication
(10) Pub. No.: US 2007/0153985 A1
(43) Pub. Date: Jul. 5, 2007

(54) Intellectual alarming system with automatic call for help

(75) Inventors: Yung-Sheng Tsao, Taipei (TW); Hui-Chen Tsai, Taipei (TW)

Correspondence Address: TROXELL LAW OFFICE PLLC, 5205 LEESBURG PIKE, SUITE 1404, FALLS CHURCH, VA, 22041, US

(73) Assignee: AGGREEN TECH. CORPORATION, TAIPEI (TW)

(21) Appl. No.: 11/585,999

(22) Filed: Oct. 25, 2006

(30) Foreign Application Priority Data
Nov. 23, 2005 (TW) 094220327

(51) Int. Cl. H04M 11/04

(52) U.S. Cl. 379/37

(57) ABSTRACT

An alarming system detects a harmful gas, an over temperature, a fire smoke, etc. and alarms a user. If the user does not respond to the alarm within a period of time, the system automatically dials a list of telephone numbers to notify receivers of the telephone numbers about the danger. With the system, the user obtains a better safeguard to his own life. And the system can also be used to prevent a house from disasters when the user is out.

### FIELD OF THE INVENTION

The present invention relates to a single hazard alarm; more particularly, relates to sounding an alarm on detecting the harmful gas, the heat and the smoke and relates to automatically dialing telephone numbers to call for help after no response to the alarm within a delay time and confirm the calls to ensure everyone on the telephone number list hearing the pre-recorded help voice message.

### DESCRIPTION OF THE RELATED ARTS

A prior art of a carbon monoxide alarming device automatically cuts a carbon monoxide source; and voices or rings are sounded for a gas leakage or an incomplete combustion by detecting too much gas or carbon monoxide. Another prior art outputs a signal and triggers an indicator light and a voice alarm detecting an abnormal density of carbon monoxide. Another prior art provides a technology to shut a hot-water heater or a hot plate to prevent from carbon monoxide poisoning by the carbon monoxide the hot-water heater or the hot plate produces. Another prior art extracts carbon monoxide in an space to prevent from carbon monoxide poisoning.

Although the above prior arts prevent the user from danger by sounding an alarm, triggering an indicator light, extracting a dangerous gas, etc., the user is not able to respond the above warnings if the user passes out. In another word, the prior arts do not have a broad monitoring area; is not used with ease independently; do not call for help when in danger; and has no function on confirming a notification of danger. Hence, the prior arts do not fulfill users' requests on actual use.

### SUMMARY OF THE INVENTION

The main purpose of the present invention is to provide an intellectual single alarming system which is able to broaden the monitoring areas and to call for help with ease of use and low

To achieve the above purpose, the present invention is an intellectual single alarming system with automatic call for help, comprising at least one detector to sending an impedance signal, a capacitive impedance signal or an electrical signal on detecting a harmful gas, an over temperature or a fire smoke; a circuit board connecting to the detector to alarm and to dial at least one telephone number on changes in signals from the detector and to receive a dual tone multi-frequency (DTMF) signal for confirmation; a telephone number memory to store telephone numbers of receivers to be notified; a telephone line socket to connect to public switched telephone network (PSTN); a power source socket to provide the power; a speaker for notification and hint with voice; an alarming component to sound an alarm; and a keypad, comprising numerical keys and functional keys, to communicate with a control system to input commands or data. Accordingly, a novel intellectual alarming system with automatic call for help is obtained.

### BRIEF DESCRIPTION OF THE DRAWINGS

The present invention will be better understood from the following detailed description of the preferred embodiment according to the present invention, taken in con junction with the accompanying drawings, in which

FIG. 1 is the perspective view showing the preferred embodiment according to the present invention;

FIG. 2 is the explosive view of the preferred embodiment;

FIG. 3 is the explosive view of the speaker and the alarming component;

FIG. 4 is the perspective bottom-up view of the seat and the keypad; and

FIG. 5 is the flow view of the preferred embodiment.

### DESCRIPTION OF THE PREFERRED EMBODIMENT

The following description of the preferred embodiment is provided to understand the features and the structures of the present invention

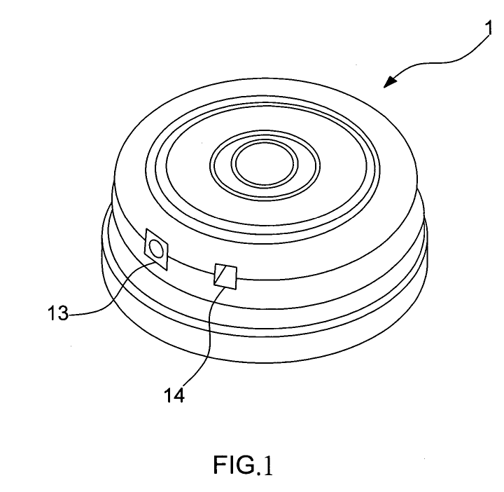

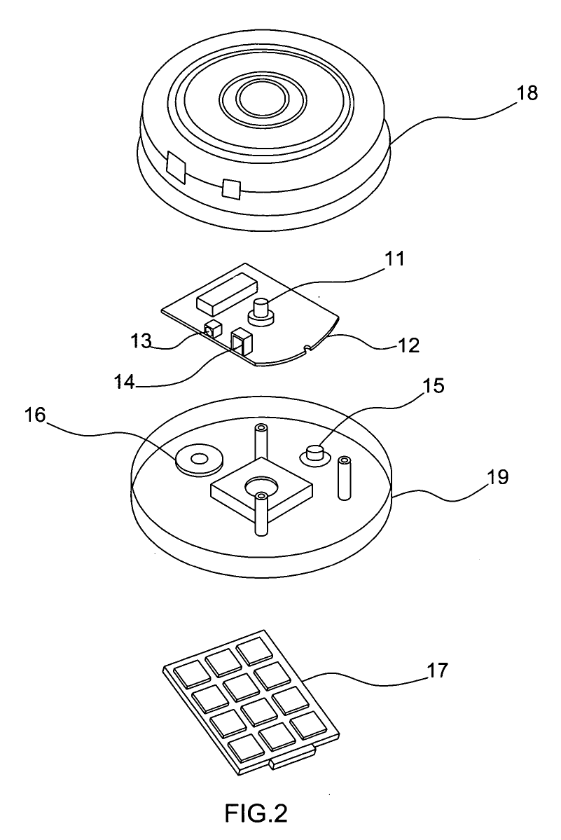

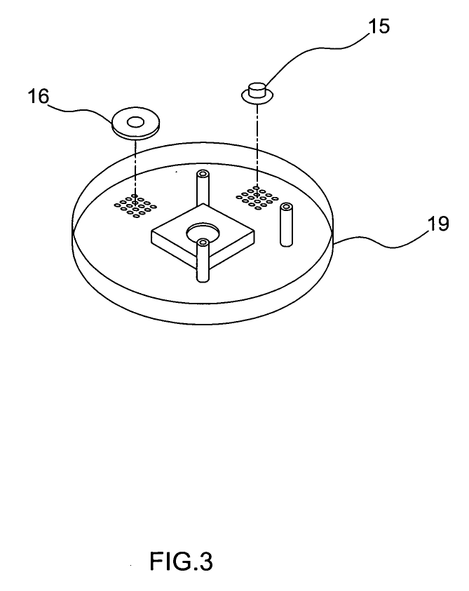

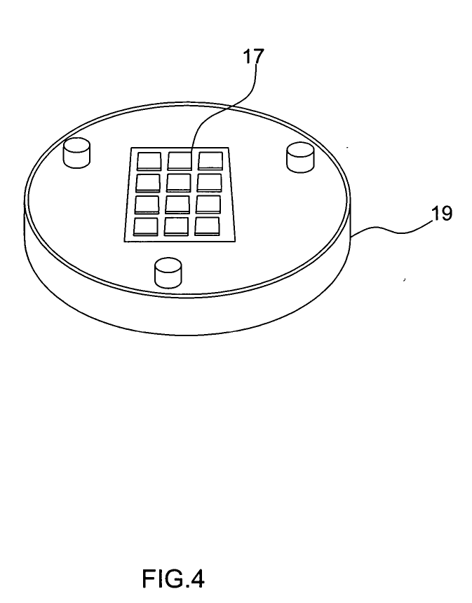

Please refer to FIG. 1 to FIG. 4, which are a perspective view and an explosive view showing the preferred embodiment, a perspective bottom-up view of a keypad and an explosive view of a speaker and an alarming component according to the present invention. As shown in the figures, the present invention is an intellectual alarming system with automatic call for help 1, comprising a detector 11, a circuit board 12, a telephone in e socket 13, a power source socket 14, a speaker 15, an alarming component 16 and a keypad 17, where the detector 11 detects an abnormal status, such as a harmful gas, an over temperature and/or a fire smoke, having a value beyond a default value set for the status; the alarming component 16 further comprises a cover 18 and a seat 19; and the circuit board 12 is deposed on the seat 19.

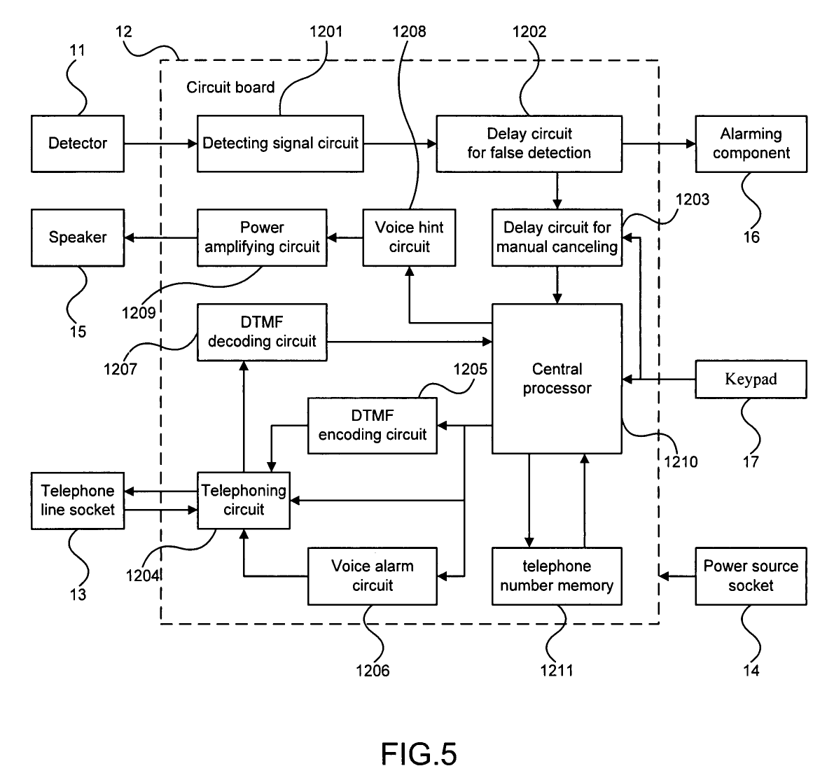

Please refer to FIG. 5 which is a flow view of the preferred embodiment. As shown in the figure, a circuit board 12 according to the present invention is connected with a detector 11 directly or through a leading wire; and the detector 11 monitors a limited space for the harmful gas, the over temperature and/or the fire smoke through a cover of aeration.

The circuit board 12 is connected with a keypad 17 for a user to input telephone numbers of receivers to be notified; is connected with a speaker 15 to play voice records to guide the user for operations and to monitor the keypad 17 on inputting; is connected with an alarming component 16 to play alarming sounds; is connected with a telephone line socket 13 to link to public switched telephone network (PSTN); and is connected with a power source socket 14 to be supplied with a power source required for operations, where the power source socket 14 is further connected with a direct current (DC) power source obtained from a transformer or a battery set (not shown in the figure) to supply power for operations of the circuit board 12.

The circuit board 12 comprises various circuits, which are a detecting signal circuit 1201, a delay circuit for false detection 1202, a delay circuit for manual canceling 1203, a telephoning circuit 1204, a DTMF encoding circuit 1205, a voice alarm circuit 1206, a DTMF decoding circuit 1207, a voice hint circuit 1208 and a power amplifying circuit 1209; a central processor 121 0; and a telephone number memory 1211. Therein, the detecting signal circuit 1201 provides impedance matching, signal amplification and waveform shaping for detectors to trigger on detecting a harmful gas, an over temperature and/or a fire smoke. The delay circuit for false detection 1202 provides a delay time to prevent false detection caused by environmental interference or temporary status; and to output a signal or an alarm by activating the alarming component 16 to warn a personing a limited space when sensing signals are lasted longer than the delay time for preventing false detection. The delay circuit for manual cancelling 1203 provides another delay time for the user to use the keypad 17 to cancel automatic dialing after the alarming component 16 is activated. The central processor 1210, like a micro-processor, a programmable array logic (Pal), a generic array logic (Gal) or a discrete circuitry, is an electrical circuit with processes of automatic controls. When sensing signals are lasted longer than the delay time for preventing false detection and the user does not cancel the automatic dialing and reset the whole system within the another delay time, the central processor 1210 sends a control signal to the telephoning circuit 1204 to connect to PSTN through the telephone line socket 13. After connecting to PSTN, the central processor 1210 reads a telephone number list of receivers stored in the telephone number memory 1211 and assumes the telephone numbers as ‘unnotified’. The first telephone number is then outputted to the DTMF encoding circuit 1205 to produce dual tones for the first telephone number to be sent to PSTN through the telephoning circuit 1204 and the telephone line socket 13 to connected to the receiver of the first telephone number. After sending the DTMF signals and waiting for a delay time, the central processor 1210 sends a control signal to the voice alarm circuit 1206 to repeatedly output a call for help and a pre-recorded voice of the address and telephone number information of the user. A recorded voice is also repeatedly replayed to ask the receiver to press down a certain key for a confirmation on receiving the notification.

The call for help and the pre-recorded voice of the information of the user is replayed for the receiver through the telephoning circuit 1204 and the telephone line socket 13. When the receiver pressed own the certain key, a DTMF signal for the certain key is sent to the DTMF decoding circuit 1207 through the telephone line socket 13 and the telephoning circuit 1204 to be decoded. Then a signal is sent to the central processor 1210 to mark the telephone number in the telephone number memory 1211 as ‘notified’. And then the central processor 1210 outputs a control signal to the voice alarm circuit 1206 to confirm the user's notification. Hence, the receiver of the first telephone number is notified and the line is hanged to be ready for notifying a receiver of the next telephone number. If the receiver of the first telephone number does not press down the certain key in a default period of time, the central processor 1210 directly goes to the next telephone number in the telephone number list; the current telephone number is not marked as notified in the telephone number memory 1211; and the current telephone number will be notified again later on. After all of the telephone numbers in the telephone number list are notified and are confirmed by receiving the signal of the certain key for each telephone number, the telephone number memory is reset to be rebooted.

In addition, the telephone number memory 1211 is a memory unit. When the user inputs the telephone numbers for notification by the keypad 17 through the central processor 1210, the central processor 1210 outputs a control signal to the voice hint circuit 1208 to output a pre-recorded help voice to the speaker 15 to guide the user's operation on inputting, storing and confirming the telephone numbers inputted by the user, where the help voice is amplified by the power amplifying circuit 1209.

To sum up, the present invention is an intellectual alarming system with automatic call for help, where a detecting area covered by the alarming system can be easily broadened by deposing at a place with a telephone line plugged; an alarm is sounded on detecting a harmful gas, an over temperature or a fire smoke; and telephone numbers in a telephone number list are notified on not receiving an instant response from a user to the alarm sounded, all of which provide a better safe guard to the user's life.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An intellectual alarming system with automatic call for help, comprising:
a detector, said detector detecting at least one element in a limited space, said detector sending a triggering signal on detecting an abnormal status, said abnormal status having a value beyond a default value set for said status;
a circuit board, said circuit board being recorded with telephone number, said circuit board being connected with said detector, said circuit board having a method of dialing said records of telephone numbers automatically after processing triggering signals of said abnormal status, said method being selected from a group consisting of a direct connection and a connection through a leading wire, said circuit board accepting dual tone multi-frequency (DTMF) signal for conformation;
a telephone line socket, said telephone line socket being connected with public switched telephone network (PSTN);
a speaker, said speaker guiding operations;
an alarming component, said alarming component sounding an alarm; and
a keypad, said keypad communicating with a control system to input commands and data, said keypad comprising numerical keys and functional keys.

2. The intellectual alarming system according to claim 1,
wherein said triggering signal is selected from a group consisting of an impedance signal, a capacitive impedance signal and an electrical signal and is processed by an electrical circuit.

3. The intellectual alarming system according to claim 1,
wherein said circuit board comprises a detecting signal circuit, a delay circuit for false detection, a delay circuit for manual cancelling, a central processor, a telephoning circuit, a voice alarm circuit, a DTMF encoding circuit, a DTMF decoding circuit, a voice hint circuit, a power amplifying circuit and a telephone number memory, said telephone number memory storing said telephone numbers; and
wherein said circuit board automatically dials said telephone numbers for notification after processing said triggering signals of said abnormal status without a response in a period of time.

4. The intellectual alarming system according to claim 1,
wherein said circuit board is further connected with a direct current (DC) power source to supply said power for operations of said circuit board; and
wherein said DC power source is obtained from a transformer or a battery set.
